(19) United States
(12) Patent Application Publication
(10) Pub. No.: US 2016/0276962 A1
(43) Pub. Date: Sep. 22, 2016

(54) Vector Currents Controller for Salient Pole Synchronous Machine

(71) Applicant: Caterpillar Inc., Peoria, IL (US)

(72) Inventors: Ahmed Khalil, Peoria, IL (US); Ernesto Inoa, Dunlap, IL (US); Baojun Si, Dunlap, IL (US); Srikar Thaduvayi, Peoria, IL (US); William J. Tate, Dunlap, IL (US)

(73) Assignee: Caterpillar Inc., Peoria, IL (US)

(21) Appl. No.: 14/661,791

(22) Filed: Mar. 18, 2015

(51) Int. Cl. H02P 6/00; H02P 6/04; H02P 6/08

(52) U.S. Cl. CPC H02P 6/002; H02P 6/08; H02P 6/04; H02P 2006/045

(57) ABSTRACT

A control system for an alternating current (AC) machine having a rotor and a stator is disclosed. The control system may include a direct current (DC) link providing a variable DC link voltage; an inverter module operatively coupled between the DC link and the AC machine, and a controller in communication with the inverter module. The inverter module may include a plurality of gates in selective communication with each phase of the stator. The controller may be configured to receive a signal indicative of the variable DC link voltage, receive a signal indicative of a rotational speed of the rotor, receive a torque command, and generate a direct-axis current command and a quadrature-axis current command using the variable DC link voltage, the rotational speed, and the torque command as inputs into a three-dimensional lookup table preprogrammed into a memory associated with the controller.

### FIELD OF THE DISCLOSURE

The present disclosure relates generally to electric drive assemblies and, more particularly, to control systems and methods for electric machines.

### BACKGROUND OF THE DISCLOSURE

With the growing interest in energy conservation, increasingly more industrial work machines are supplied with electric drive assemblies for driving the work machine and operating its various tools or functions. Ongoing developments in electric drives have made it possible for electrically driven work machines to effectively match or surpass the performance of purely mechanically driven work machines while requiring significantly less fuel and overall energy. As electric drive assemblies become increasingly more commonplace with respect to industrial work machines and the like, the demands for more efficient generators and techniques for controlling same have also increased.

For example, some conventional electric drive assemblies waste retarding energy, such as, during downhill operation of the industrial work machines. More specifically, the wheels, or traction devices, are not coupled to the engine in work machines with electric drive assemblies. As such, the retarding energy during downhill operation cannot be utilized to reduce fuel consumption of the engine. Typically, the retarding energy is burned off in a braking grid. Accordingly, there is a need to provide a control system and method that recovers and utilizes retarding energy in order to reduce fuel consumption of the engine.

A method for controlling a claw-pole synchronous machine is disclosed in U.S. Pat. No. 6,707,277, entitled, “Method of Controlling Claw-Pole Synchronous Machine.” The '277 patent describes a claw-pole synchronous machine including a field system that is implemented as a rotor and which includes a field coil wound around a core. A field current is supplied to the field coil for exciting the field system to generate magnetic flux in the direct-axis direction. The '277 claw-pole synchronous machine further includes armature coils that are implemented as the constituent parts of a stator disposed around the field system.

In the '277 patent, the field current is controlled on the basis of a demanded torque to be outputted and a rotational speed of the claw-pole synchronous machine. Furthermore, the field weakening control is realized with the armature current by controlling the magnitude and the phase difference of the armature current. While effective, improvements are desired in order to recover retarding energy.

### SUMMARY OF THE DISCLOSURE

In accordance with one embodiment, a control system for an alternating current (AC) machine having a rotor and a stator is disclosed. The control system may include a direct current (DC) link providing a variable DC link voltage; an inverter module operatively coupled between the DC link and the AC machine, and a controller in communication with the inverter module. The inverter module may include a plurality of gates in selective communication with each phase of the stator. The controller may be configured to: receive a signal indicative of the variable DC link voltage; receive a signal indicative of a rotational speed of the rotor; receive a torque command; and generate a direct-axis current command and a quadrature-axis current command using the variable DC link voltage, the rotational speed, and the torque command as inputs into a three-dimensional lookup table preprogrammed into a memory associated with the controller.

In accordance with another embodiment, a method of controlling an alternating current (AC) machine is disclosed. The AC machine may have a rotor, a stator, an inverter module operatively coupled to the stator and including a plurality of gates in selective communication with each phase of the stator, and a controller in communication with the inverter module. The method may include: receiving, by the controller, a signal indicative of the variable DC link voltage; receiving, by the controller, a signal indicative of the rotational speed of the rotor; receiving, by the controller, a torque command; and inputting, by the controller, the variable DC link voltage, the rotational speed, and the torque command into a first three-dimensional lookup table preprogrammed into a memory associated with the controller and configured to output a direct-axis (d-axis) current command and a quadrature-axis (q-axis) current command based on said inputs.

In accordance with yet another embodiment, an electric drive is disclosed. The electric drive may include a first electric machine operatively coupled to a traction device. The first electric machine may be configured to convert mechanical energy from the traction device into alternating current (AC). The electric drive may further include a first inverter module operatively coupled to the first electric machine. The first inverter module may be configured to convert the AC from the first electric machine into a variable direct current (DC) link voltage on a DC link. The electric drive may further include a second inverter module operatively coupled to the first inverter module via the DC link, a second electric machine operatively coupled between the second inverter module and a power source, and a controller in communication with the second inverter module.

The second inverter module may configured to convert the variable DC link voltage into AC. The second electric machine may include a stator and a rotor, and may be configured to convert the AC from the second inverter into mechanical energy for the power source. The controller may be configured to: receive a signal indicative of the variable DC link voltage on the DC link; receive a signal indicative of a rotational speed of the rotor of the second electric machine; receive a torque command for the second electric machine; generate a direct-axis (d-axis) current command for the second inverter module as a function of the variable DC link voltage, the rotational speed, and the torque command; and generate a quadrature-axis (q-axis) current command for the second inverter module as a function of the variable DC link voltage, the rotational speed, and the torque command.

These and other aspects and features will become more readily apparent upon reading the following detailed description when taken in conjunction with the accompanying drawings. In addition, although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a diagrammatic view of a machine, in accordance with one embodiment of the present disclosure;

FIG. 2 is a schematic representation of an electric drive with a control system, in accordance an embodiment of the present disclosure;

FIG. 3 is a schematic representation of an inverter module for the electric drive of FIG. 2;

FIG. 4 is a graphical view of an example available DC link voltage for the electric drive of FIG. 2;

FIG. 5 is a functional block diagram of an algorithm for the control system of FIG. 2;

FIG. 6 is a graphical view of an example plot for a three-dimensional (3D) lookup table of the control system of FIG. 2;

FIG. 7 is a graphical view of another example plot for a 3D lookup table of the control system of FIG. 2;

FIG. 8 is a graphical view of another example plot for a 3D lookup table of the control system of FIG. 2;

FIG. 9 is a graphical view of another example plot for a 3D lookup table of the control system of FIG. 2;

FIG. 10 is a graphical view of yet another example plot for a 3D lookup table of the control system of FIG. 2;

FIG. 11 is a diagrammatic view of a salient pole synchronous (SPS) machine for the electric drive of FIG. 2;

FIG. 12 is a schematic representation of a 3D lookup table for the control system of FIG. 2; and

FIG. 13 is a flowchart illustrating an example process for controlling an alternating current (AC) machine, in accordance an embodiment of the present disclosure.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

The present disclosure provides an electric drive that utilizes retarding energy in order to reduce fuel consumption of an engine in an industrial work machine. The disclosed electric drive includes a first electric machine coupled to a traction device of the work machine. The first electric machine recovers retarding energy from the traction device, and a first inverter module converts the recovered retarding energy into a variable direct current (DC) link voltage on a DC link.

A second inverter module is coupled to the first inverter module via the DC link. The second inverter module converts the variable DC link voltage into alternating current (AC) for a second electric machine, which is coupled to the engine. In so doing, the second electric machine may drive the engine, thereby supporting parasitic loads of the engine using retarding energy and drastically reducing fuel consumption.

Furthermore, the present disclosure provides a control system and method for an alternating current (AC) machine. The disclosed control system and method includes a controller in communication with the second inverter module that is configured to determine a d-axis current command and a q-axis current command based in part on the variable DC link voltage. In so doing, the disclosed system and method may control the second electric machine given the variable DC link voltage of the recovered retarding energy.

Reference will now be made in detail to specific embodiments or features, examples of which are illustrated in the accompanying drawings. Generally, corresponding reference numbers will be used throughout the drawings to refer to the same or corresponding parts.

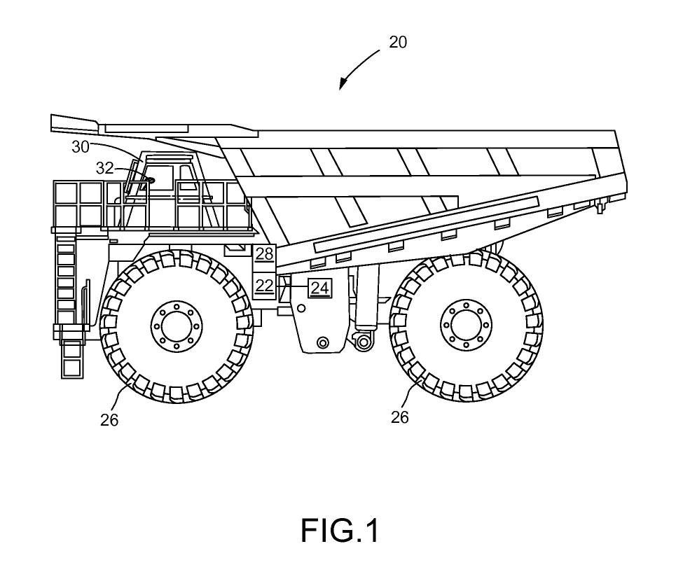

FIG. 1 illustrates a machine 20 consistent with certain embodiments of the present disclosure. It is to be understood that although the machine 20 is illustrated as a mining truck, the machine 20 may be of any other type. As used herein, the term “machine” refers to a mobile machine that performs a driven operation involving physical movement associated with a particular industry, such as, mining, construction, landscaping, forestry, transportation, agriculture, etc.

Non-limiting examples of machines include commercial and industrial machines, such as, mining vehicles, on-highway vehicles, trains, earth-moving vehicles, loaders, excavators, dozers, motor graders, tractors, trucks, backhoes, agricultural equipment, material handling equipment, and other types of machines that operate in a work environment. It is to be understood that the machine 20 is shown primarily for illustrative purposes to assist in disclosing features of various embodiments, and that FIG. 1 does not depict all of the components of a machine.

The machine 20 may include a power source 22 that is coupled to an electric drive 24 for causing movement via one or more traction devices 26. Although traction devices 26 are shown as wheels, in FIG. 1, traction devices 26 may be of any other type. The power source 22 of the electric drive 24 may include, for example, a diesel engine, a gasoline engine, a natural gas engine, or any other source of mechanical or rotational energy commonly used for generating power. The electric drive 24 may also be used in conjunction with any other suitable source of power, such as, for example, a battery, a fuel cell, and the like. The power source 22 may be operatively configured to transmit power to parasitic loads 28.

The machine 20 may also include an operator cab 30 that houses an operator interface 32 configured to receive input from and output data to an operator of the machine 20. The operator interface 32 may include a plurality of operator controls for controlling operation of the machine 20 and implements connected thereto. Examples of operator controls may include one or more pedals, joysticks, buttons, switches, dials, levers, steering wheels, keyboards, touchscreens, displays, monitors, screens, lights, speakers, horns, sirens, buzzers, voice recognition software, microphones, control panels, instrument panels, gauges, etc.

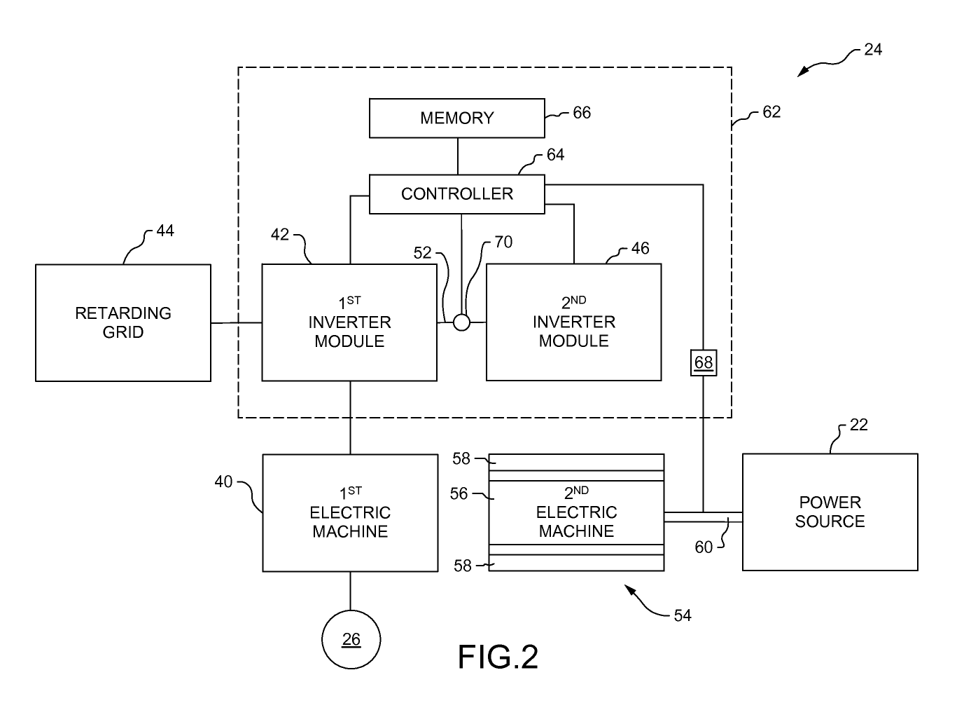

Referring now to FIG. 2, with continued reference to FIG. 1, the electric drive 24 is shown, in accordance with an embodiment of the present disclosure. The electric drive 24 may include a first electric machine 40 operatively coupled to the one or more traction devices 26. The first electric machine 40 may comprise an alternating current (AC) machine, such as, an interior permanent magnet (IPM) machine. However, other types of electric machines may be used.

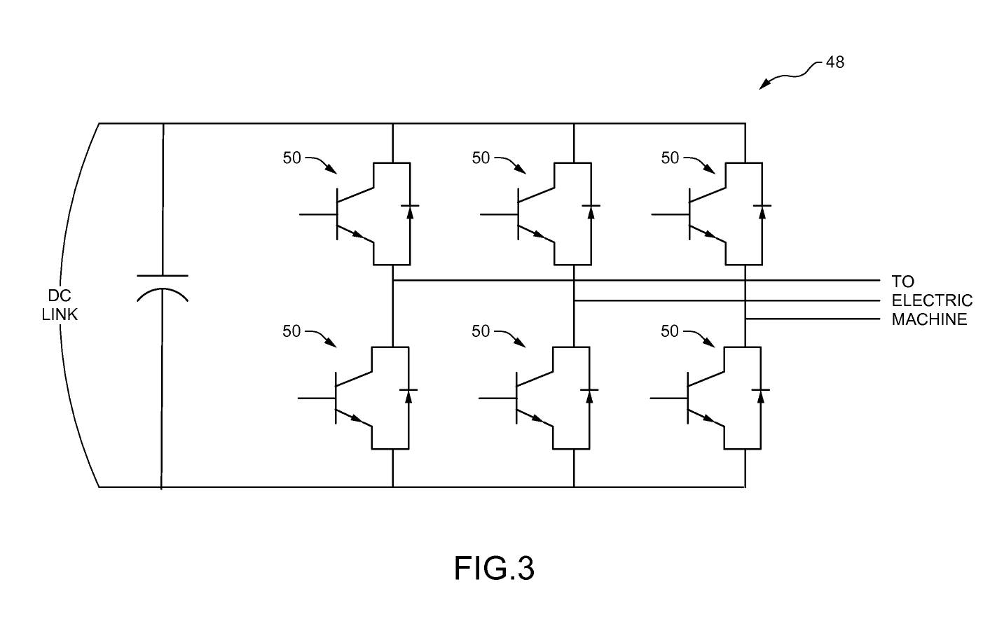

A first inverter module 42 may be operatively coupled to the first electric machine 40. The first inverter module 42 may also be operatively coupled to a retarding grid 44 and a second inverter module 46. The retarding grid 44 may be configured to dissipate energy into grid resistors and the like. Each of the first inverter module 42 and the second inverter module 46 may comprise a three-phase inverter 48 including a plurality of power switching devices or gates 50, such as that shown in FIG. 3. Other configurations than that shown in FIG. 3 may be used for the first inverter module 42 and the second inverter module 46. Referring back to FIG. 2, the first inverter module 42 and the second inverter module 46 may be connected to each other via a direct current (DC) link 52.

Operatively coupled to the second inverter module 46, a second electric machine 54 may include a rotor 56 rotatably disposed within a fixed stator 58. The second electric machine 54 may comprise any type of AC machine, although other types of electric machines may be used. The rotor 56 of the second electric machine 54 may be rotatably coupled to an output of the power source 22 via a coupling or axially rotating drive shaft 60. In other embodiments, the rotor 56 may be coupled to the power source 22 via a direct crankshaft, a gear train, a hydraulic circuit, and the like. The plurality of gates 50 of the second inverter module 46 may be in communication with each phase or phase winding of the stator 58 in order to selectively enable or disable each of the three phases of the second electric machine 54.

Still referring to FIG. 2, in a propulsion mode of the electric drive 24, the power source 22 consumes fuel in order to provide mechanical energy on the drive shaft 60. The second electric machine 54 may convert the mechanical energy from the drive shaft 60 into electrical energy. The first inverter module 42 and/or second inverter module 46 may apply that electrical energy to the parasitic loads 28 (FIG. 1). For example, electrical energy may be supplied to the first electric machine 40 in order to drive traction devices 26, and may also be supplied to other electric loads, such as, a hybrid system, electrically driven pumps, electrically driven fans, and other accessary loads.

In a retarding mode of the electric drive 24, the first electric machine 40 may be configured to recover electrical energy from traction devices 26. For example, during downhill operation of the machine 20, the first electric machine 40 may convert excess mechanical energy from the traction devices 26 into variable AC supplied to the first inverter module 42. The first inverter module 42 may convert the variable AC into a variable DC link voltage, which may be burned off in the retarding grid 44 and/or supplied to the second inverter module 46 via DC link 52. When supplied to the second inverter module 46, the second inverter module 46 may convert the variable DC link voltage into AC for use by the second electric machine 54, which may propel the power source 22. In so doing, the recovered retarding energy may be used to reduce fuel consumption by the power source 22.

The electric drive 24 may be provided with a control system 62. The control system 62 may be configured to control the electric drive 24 in the propulsion mode and the retarding mode. Although not discussed in detail, it is to be understood that the control system 62 may control the electric drive 24 in propulsion mode according to any suitable control strategy known in the art. In retarding mode, the control system 62 may control the electric drive 24 based at least in part on the variable DC link voltage on the DC link 52, in accordance with an embodiment of the present disclosure.

Furthermore, the control system 62 may generally include the first inverter module 42, the second inverter module 46, at least one controller 64 in communication with the plurality of gates 50 in the first inverter module 42 and the second inverter module 46, and a memory 66 associated with the controller 64 that is provided within and/or external to the controller 64. More specifically, the controller 64 may be electrically coupled to the gates 50 in the second inverter module 46 in a manner which enables the controller 64 to selectively engage the gates 50 and source current through the different phases of the second electric machine 54, as well as in a manner which enables the controller 64 to monitor electrical characteristics of the second electric machine 54 and the variable DC link voltage of the DC link 52 during operation of the second electric machine 54, such as, in retarding mode.

It is to be understood that the controller 64 may also be electrically coupled to the gates 50 in the first inverter module 42 in a similar manner as described above with the second inverter module 46. The memory 66 associated with the controller 64 may comprise a non-volatile memory. The memory 66 may retrievably store one or more algorithms, machine data, predefined relationship between different machine parameters, preprogrammed models, such as in the form of lookup tables and/or maps, and any other information that may be accessed by the controller 64 and relevant to the operation of the first electric machine 40 and the second electric machine 54.

The controller 64 may be implemented using one or more of a processor, a microprocessor, a microcontroller, a digital signal processor (DSP), a field-programmable gate array (FGPA), an electronic control module (ECM), and electronic control unit (ECU), or any other suitable means for electronically controlling functionality of the control system 62. The controller 64 may be configured to operate according to predetermined algorithms or sets of instructions for operating the electric drive 24, the first electric machine 40, and the second electric machine 54. Such algorithms or sets of instructions may be preprogrammed or incorporated into the memory 66 that is associated with or at least accessible to the controller 64. The control system 62 and controller 64 may include other hardware, software, firmware, and combinations thereof.

For example, the control system 62 may also include a rotor position sensor 68 and a voltage sensor 70. The rotor position sensor 68 may be configured to detect an angular position of the rotor 56 of the second electric machine 54, although other types of sensors or sensorless means may be used to determine the angular position of the rotor 56. The voltage sensor 70 may be configured to detect an amount of the variable DC link voltage on the DC link 52. However, other types of sensors or sensorless means may be used to determine the variable DC link voltage.

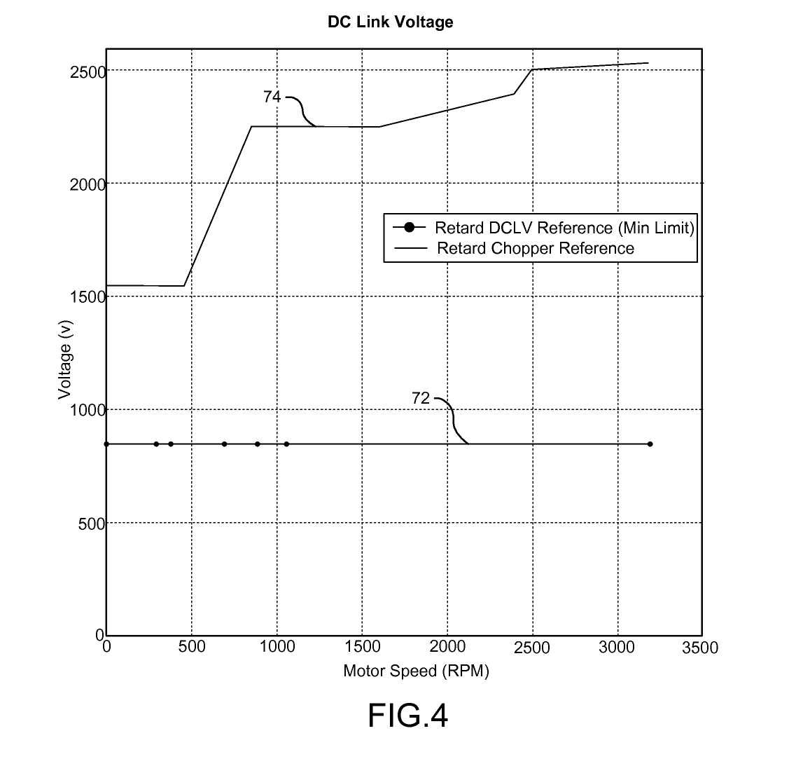

For instance, the voltage sensor 70 may detect the DC link voltage on DC link 52, which varies depending on a speed of the first electric machine 40 in retarding mode, as shown in FIG. 4. In the example of FIG. 4, a minimum available voltage is represented by line 72, and a maximum available voltage is represented by line 74. Depending on the speed of the first electric machine 40 in retarding mode, represented by the x-axis, the DC link voltage in the DC link 52 can be anywhere between the minimum available voltage and the maximum available voltage. In FIG. 4, the DC link voltage may vary between an inclusive range of approximately 800 V to 2700 V, although other ranges and values for the minimum available voltage and the maximum available voltage may be used.

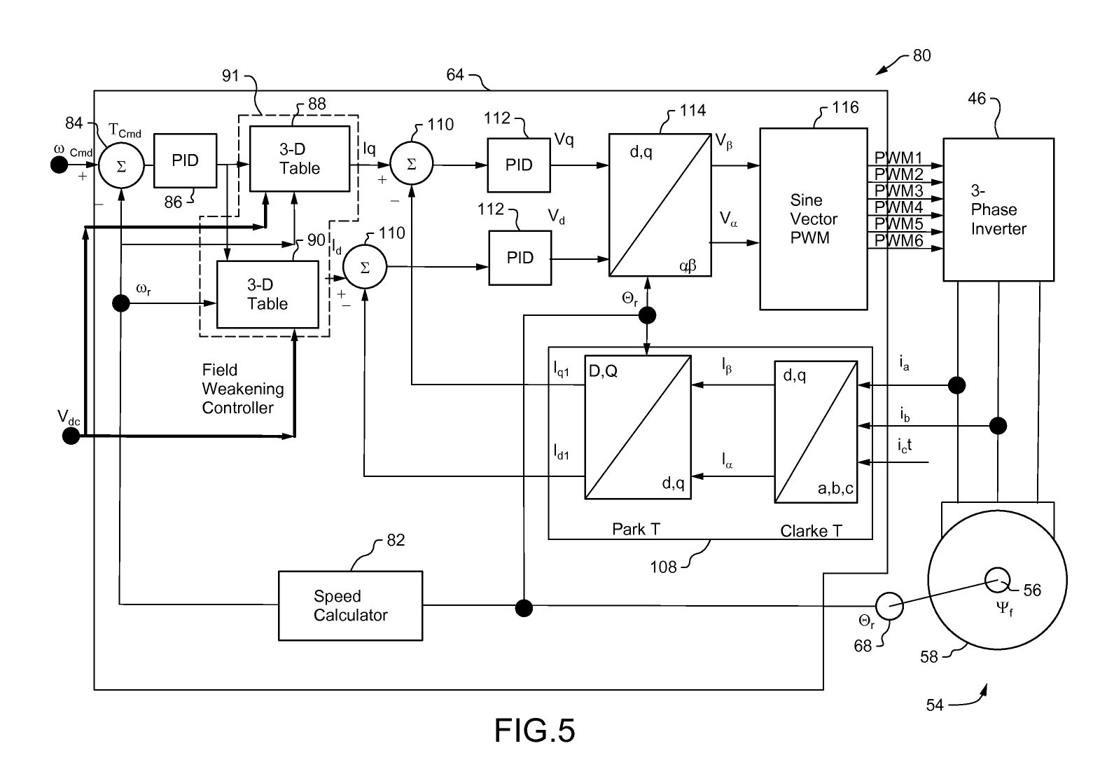

Turning now to FIG. 5, with continued reference to FIGS. 1-4, a functional block diagram 80 of an example algorithm of the control system 62 is shown, according to an embodiment of the present disclosure. The control system 62 may control the second electric machine 54 based on the variable DC link voltage v_{dc} from the DC link 52, a rotational speed ωᵣ of the rotor 56 of the second electric machine 54, and a torque command T_{Cmd}. More specifically, the controller 64 may receive a signal indicative of the DC link voltage v_{dc} from the voltage sensor 70.

In addition, the controller 64 may receive a signal indicative of the rotational speed ωᵣ of the second electric machine 54 from a speed calculator module 82. For example, the controller 64 may receive signals indicative of the angular position θᵣ of the rotor 56 from the rotor position sensor 68. The speed calculator module 82 may calculate the rotational speed ωᵣ of the rotor 56 of the second electric machine 54 based on the detected angular position θᵣ over time.

The controller 64 may receive a signal indicative of the torque command T_{Cmd} based on operating conditions of the machine 20. The controller 64 may be in communication with the operator interface 32 (FIG. 1) and may be configured to receive the torque command T_{Cmd} from operator input into the operator controls of the operator interface 32. In one example, the torque command T_{Cmd} may be implemented in a torque control mode. In the torque control mode, the controller 64 may receive the torque command T_{Cmd} from a pedal, a lever, a computer input, or any other mechanical, electrical, or electromechanical device by which the operator may send commands to the controller 64. For instance, the operator control may be an acceleration pedal of the machine 20, and the controller 64 may receive a torque command T_{Cmd} responsive to the degree to which the operator depresses the acceleration pedal.

In another example, the torque command T_{Cmd} may be implemented in a speed control mode. More specifically, the torque command T_{Cmd} may be based on the detected rotational speed ωᵣ of the rotor 56 of the second electric machine 54, such as, from the speed calculator module 82, and a commanded rotational speed ω_{Cmd} received from the operator input into the operator controls, such as, from the acceleration pedal of the machine 20. An error between the detected rotational speed ωᵣ and commanded rotational speed ω_{Cmd} may be calculated via module 84 and minimized via a proportional-integral derivative (PID) controller 86 in order to generate the torque command T_{Cmd}.

The controller 64 may be configured to generate a direct-axis (d-axis) current command I_{d} and a quadrature-axis (q-axis) current command I_{q} based on the variable DC link voltage v_{dc} from the DC link 52, the rotational speed ωᵣ of the rotor 56 of the second electric machine 54, and the torque command T_{Cmd}. The d-axis current command I_{d} and the q-axis current command I_{q} may be used in a vector control strategy to control the second electric machine 54. Using vector control, the torque producing and magnetizing components of the stator flux may be separately controlled to achieve DC motor-like performance.

In particular, vector control decouples the stator current flux component from the rotor current torque component. Thus, the d-axis current command I_{d} may correspond to the stator current flux component, and the q-axis current command I_{q} may correspond to the rotor current torque component. In the retarding mode of the electric drive 24, the d-axis current command I_{d} and the q-axis current command I_{q} may not only depend the rotational speed ωᵣ and the torque command T_{Cmd} for the second electric machine 54, but also on the DC link voltage v_{dc} from the DC link 52, which varies based on an amount of energy or power recovered during retarding of the machine 20.

For example, the controller 64 may be configured to use three-dimensional (3D) lookup tables 88, 90 in order to generate the d-axis current command I_{d} and the q-axis current command I_{q}. The 3D lookup tables 88, 90 may be preprogrammed into the memory 66 associated with the controller 64. Furthermore, the 3D lookup tables 88, 90 may accept the variable DC link voltage v_{dc}, the rotational speed ωᵣ, and the torque command T_{Cmd} as inputs, and output the d-axis current command I_{d} and the q-axis current command I_{q}. For instance, a first 3D lookup table 88 may be used for the d-axis current command I_{d} and a second 3D lookup table 90 may be used for the q-axis current command I_{q}.

More specifically, the first 3D lookup table 88 may accept the variable DC link voltage v_{dc}, the rotational speed ωᵣ, and the torque command T_{Cmd} as inputs, and output the d-axis current command I_{d} based on those inputs. Similarly, the second 3D lookup table 90 may accept the variable DC link voltage v_{dc}, the rotational speed ωᵣ, and the torque command T_{Cmd} as inputs, and output the q-axis current command I_{d} based on those inputs. Although there are two 3D lookup tables 88, 90 shown in FIG. 5, more or less than two 3D lookup tables 88, 90 may be used. For instance, 3D lookup tables 88, 90 may be combined into a single 3D lookup table, as denoted by broken line 91.

The 3D lookup tables 88, 90 may be generated using an iterative computer calculation technique that calculates a d-axis current command I_{d} and a q-axis current command I_{q} for each corresponding value of DC link voltage v_{dc}, rotational speed ωᵣ, and torque command T_{Cmd}. The 3D lookup tables 88, 90 may be generated based on the properties and performance characteristics of a particular electric machine.

For instance, 3D lookup tables 88, 90 may be based at least in part on the following equation for torque:

$$T = \frac{3}{2} P \times ( {Ψ}_{f} \times {i}_{q} + ( {L}_{d} - {L}_{q} ) \times {i}_{d} \times {i}_{q} ) \qquad ( 1 )$$

where T represents the torque, P represents a number of poles in the rotor 56 of the second electric machine 54, Ψ_{f} represents a magnetic flux from the rotor 56, i_{d} represents the flux current component, i_{q} represents the torque current component, L_{d} represents a d-axis self-inductance, and L_{q} represents a q-axis self-inductance. Therefore, the torque T may be calculated at least in part by adding together an electromagnetic torque (Ψ_{f}×i_{q}) with a reluctance torque ((L_{d}−L_{q})×i_{d}×i_{q}) of the second electric machine 54, as shown in equation (1) above.

The 3D lookup tables 88, 90 may also be based at least in part on the following current constraint equation:

I_{S}≧\sqrt{i_{d}²+i_{q}^{d}} (2)

where I_{S} represents a stator current of the second electric machine, i_{d} represents the flux current component, and i_{q} represents the torque current component.

In addition, 3D lookup tables 88, 90 may be based at least in part on the following voltage constraint equation:

V_{DC}≧\sqrt{(ωₑ·L_{q}·i_{q})²+(ωₑ·L_{d}·i_{d}+ωₑ·Ψ_{f})²} (3)

where V_{DC} represents an available DC link voltage, ωₑ represents a speed of the rotor 56, L_{d} represents a d-axis self-inductance, L_{q} represents a q-axis self-inductance, i_{d} represents the flux current component, i_{q} represents the torque current component, and Ψ_{f} represents a magnetic flux from the rotor 56. However, other electrical and thermal constraints of the electric drive 24 may also be taken into consideration, such as, a maximum inverter phase current, a maximum switching frequency, and a required bus voltage to overcome the back electromotive force (EMF) and deliver the requisite currents for the requested torque.

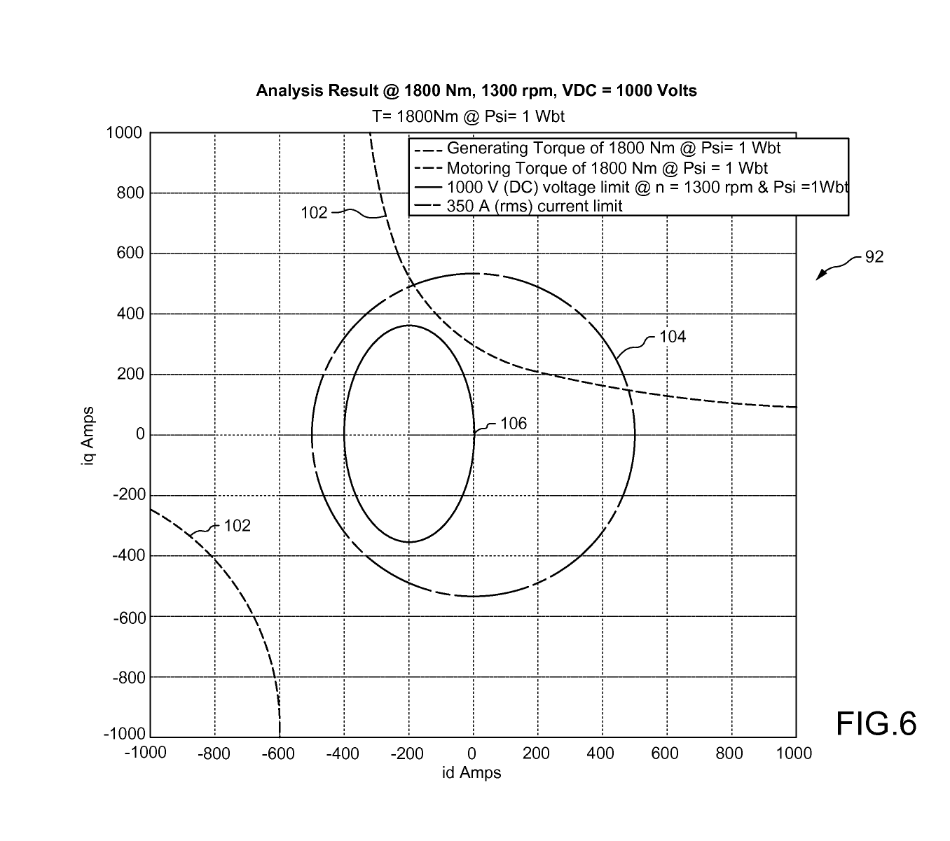

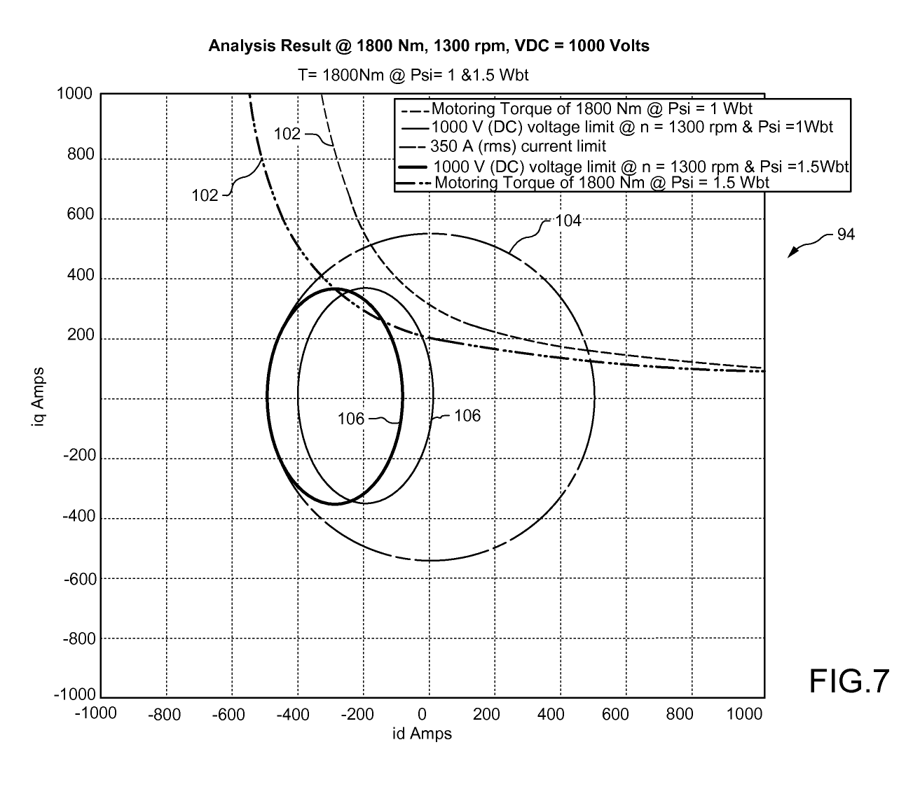

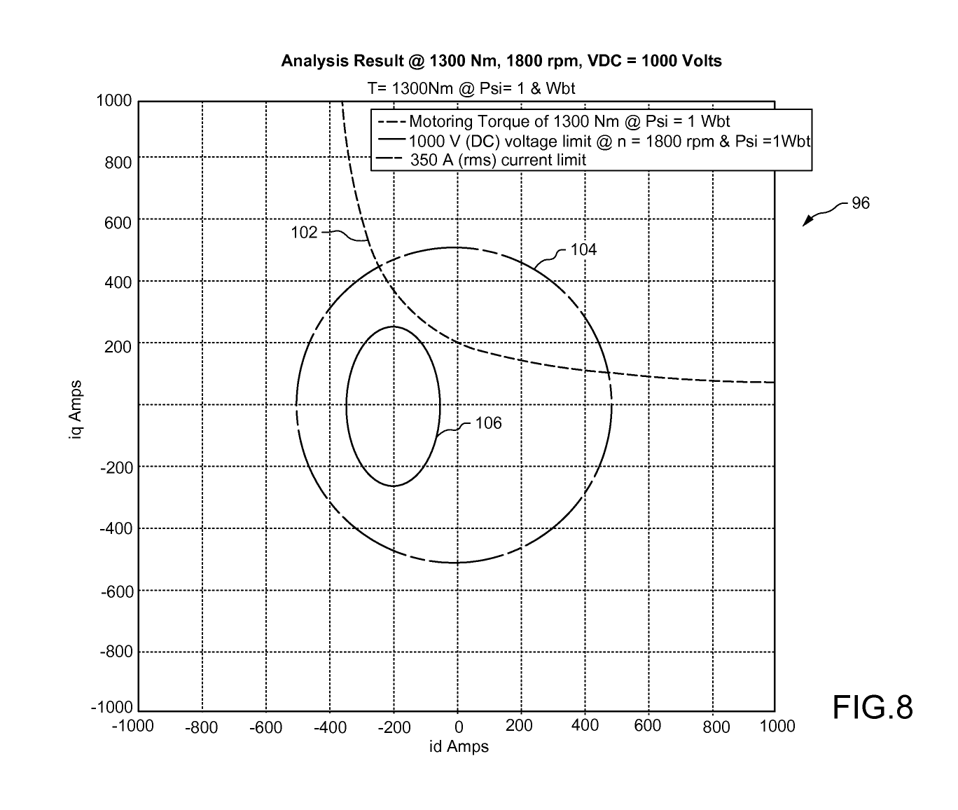

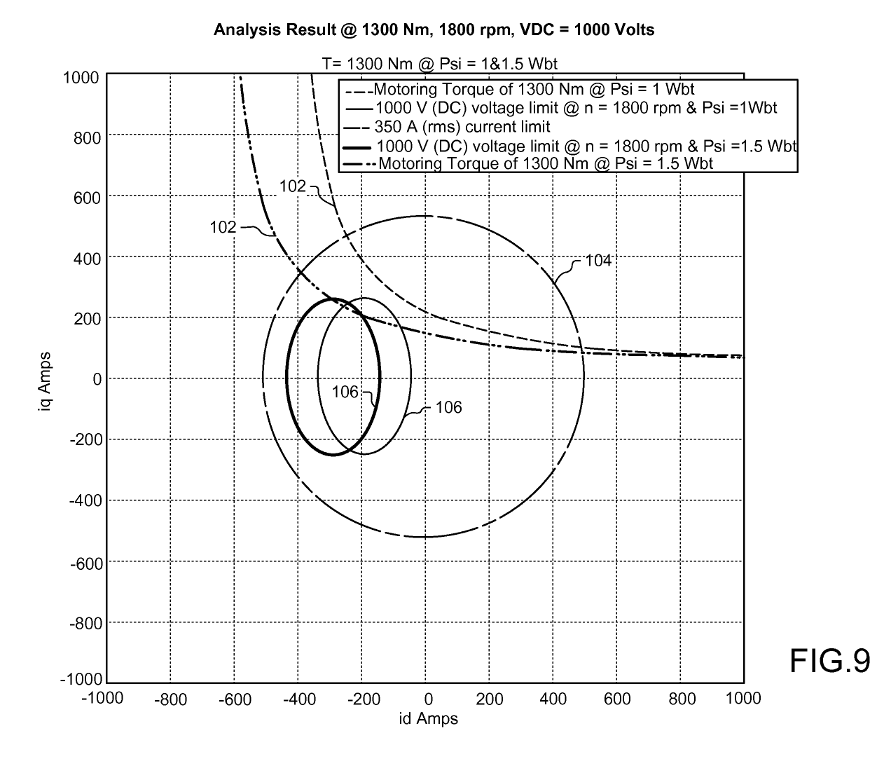

Moreover, 3D lookup tables 88, 90 may be generated by using the above equations (1)-(3) and plotting 3D maps as a function of DC link voltage v_{dc}, rotational speed ωᵣ, and torque command T_{Cmd}. For instance, example plots 92, 94, 96, 98, and 100, shown in FIGS. 6-10, demonstrate analysis results for various values of DC link voltage v_{dc}, rotational speed ωᵣ, and torque command T_{Cmd}. In example plots 92, 94, 96, 98, and 100, curves 102 were plotted using the torque equation (1) above, curves 104 were plotted using the current constraint equation (2) above, and curves 106 were plotted using the voltage constraint equation (3) above.

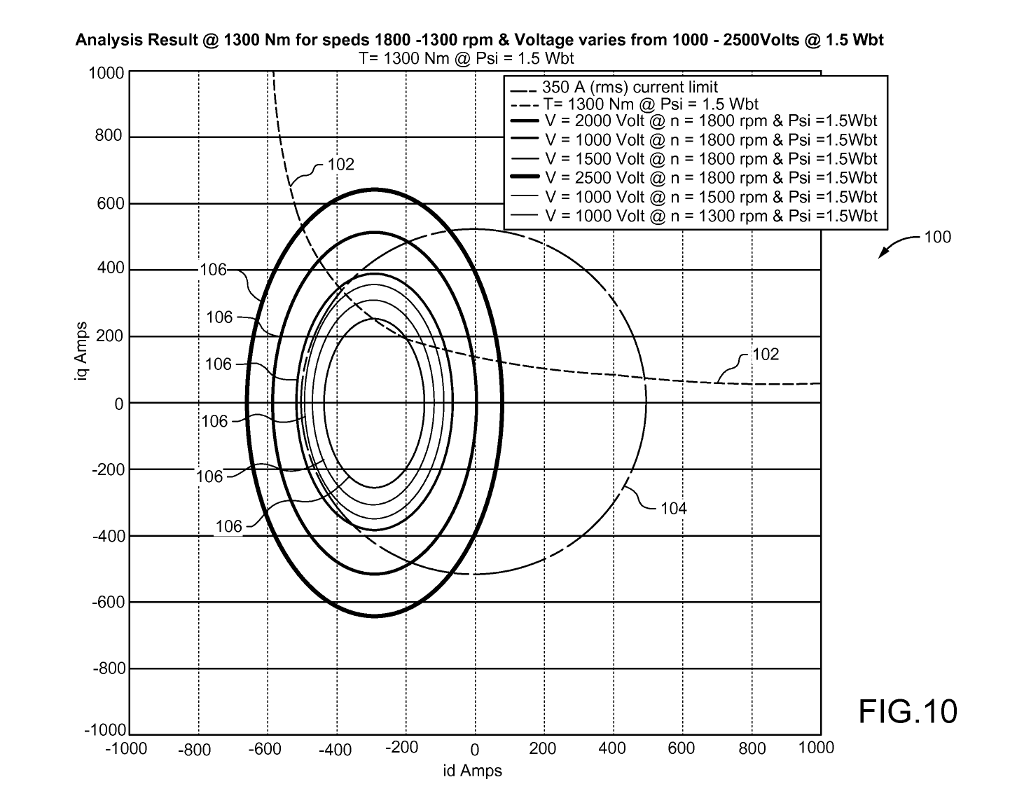

As shown in example plots 94, 98, and 100, multiple sets of values for the d-axis current command I_{d} and the q-axis current command I_{q} may satisfy the above current constraint equation (2) and the above voltage constraint equation (3). Furthermore, since the DC link voltage on DC link 52 is variable, and not fixed, during retarding mode, the second electric machine 54 can obtain an increase in torque with an increase in DC link voltage, as shown in example plot 100 of FIG. 10. As a result of the increased torque that can be gained from the variable DC link voltage, the electric drive 24 achieves an increase in power that can be utilized to alleviate the parasitic loads 28 tied to the power source 22. In so doing, the electric drive 24 may drastically reduce fuel consumption by the power source 22 in retarding mode.

Thus, by plotting the above equations (1)-(3), 3D lookup tables 88, 90 may be generated for certain values of DC link voltage v_{dc}, rotational speed ωᵣ, and torque command T_{Cmd} and stored in the memory 66 associated with the controller 64. During the retarding mode of the machine 20, the controller 64 may input real-time values for DC link voltage v_{dc}, rotational speed ωᵣ, and torque command T_{Cmd} into the 3D lookup tables 88 and retrieve the corresponding d-axis current command I_{d} and q-axis current command I_{q} that satisfy the current and voltage constraints of the second electric machine 54. It is to be understood that the values for the DC link voltage v_{dc}, rotational speed ωᵣ, and torque command T_{Cmd} in example plots 92, 94, 96, 98, and 100 were used for example purposes only and that other values for DC link voltage v_{dc}, rotational speed ωᵣ, and torque command T_{Cmd} may be used.

Referring back to FIG. 5, once the controller 64 generates the d-axis current command I_{d} and the q-axis current command I_{q} based on the DC link voltage v_{dc}, rotational speed ωᵣ, and torque command T_{Cmd} inputs into 3D lookup tables 88, 90, the controller 64 may implement vector control with pulse width modulation (PWM) on the second electric machine 54. More specifically, in module 108, Clarke and Park transformations may be performed on detected three phase current signals iₐ, i_{b}, and i_{c} from the second inverter module 46 in order to obtain a detected d-axis current I_{d1} and a detected q-axis current I_{q1}. An error between the detected currents I_{d1}, I_{q1} and the generated current commands I_{d}, I_{q} may be calculated via modules 110 and minimized via PID controllers 112 in order to generate voltage commands V_{d}, V_{q}.

Using the detected angular position θᵣ of the rotor 56, inverse Park module 114 may transform stationary voltage commands V_{d}, V_{q} into voltage commands V_{α}, V_{β} in the two phase rotating domain. PWM module 116 may implement sine wave PWM on voltage commands V_{α}, V_{β} in order to generate control signals PWM1-PWM6 used to control the plurality of gates 50 in the second inverter module 46. The plurality of gates 50 in the second inverter module 46 may then selectively enable or disable each phase of the stator 58 of the second electric machine 54, which causes the rotor 56 to rotate, thereby providing mechanical energy to the power source 22 which is coupled to the rotor 56 via drive shaft 60. It is to be understood that other control strategies and modules than that described and shown in FIG. 5 may be used to control the second electric machine 54.

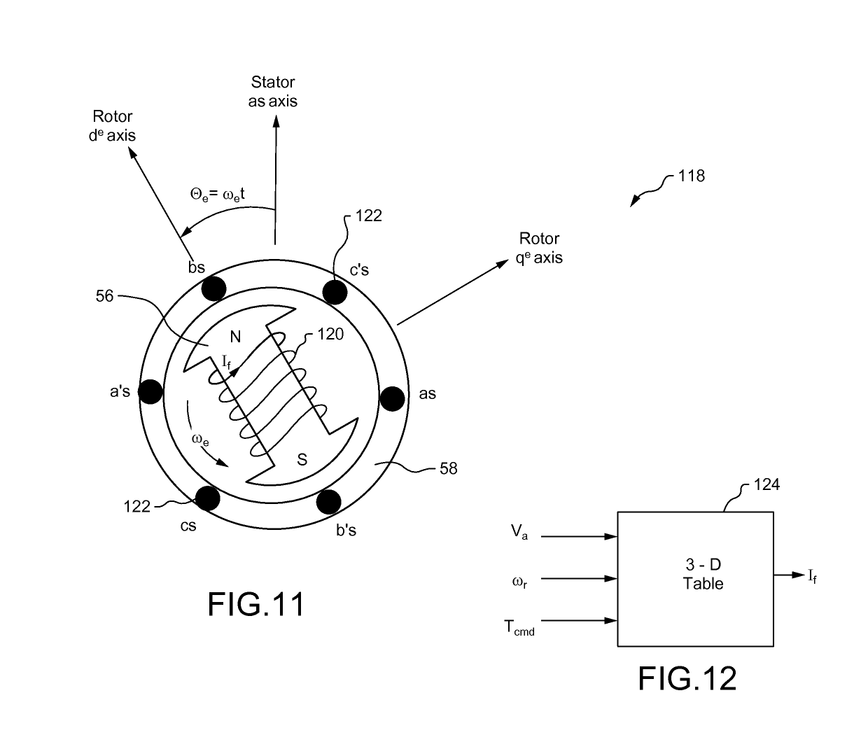

Turning now to FIG. 11, with continued reference to FIGS. 1-10, the second electric machine 54 may comprise a salient pole synchronous (SPS) machine 118. As shown in FIG. 11, the SPS machine 118 may include a coil 120 wound around the rotor 56. A field current I_{f} may be supplied to the coil 120, such as via a small brushless generator, on the rotor 56. The field current I_{f} may create rotor flux through the coil windings on the rotor 56. An interaction between the rotor flux and the stator rotating magnetic flux (RMF) produced by current 122 in the stator 58 produces electromagnetic torque.

According to another embodiment of the present disclosure, the controller 64 of the control system 62 may be configured to control the field current I_{f} in the SPS machine 118 based on the variable DC link voltage v_{dc} on the DC link 52, the rotational speed ωᵣ of the rotor 56 of the second electric machine 54, and the torque command T_{Cmd}. For example, as shown in FIG. 12, the control system 62 may include a 3D lookup table 124, implemented in a similar manner as 3D lookup tables 88, 90 for the d-axis current command I_{d} and the q-axis current command I_{q} described above. The 3D lookup table 124 may accept the variable DC link voltage v_{dc}, rotational speed ωᵣ, and torque command T_{Cmd} as inputs and output the field current command I_{f}. In so doing, the field current I_{f} may also vary as a function of the DC link voltage v_{dc}, rotational speed ωᵣ, and torque command T_{Cmd}.

### INDUSTRIAL APPLICABILITY

In general, the foregoing disclosure finds utility in various industrial applications, such as, in mining, transportation, earthmoving, construction, industrial, agricultural, and forestry vehicles and machines. In particular, the disclosed electric drive, control system and method may be applied to electric machines being employed as motors and/or generators. For example, the disclosed systems and methods may be employed in associated with the electric drives of power generation machines, industrial work vehicles, and other types of stationary or mobile machines. The present disclosure may also be implemented with other variable-speed drives commonly used in association with industrial and consumer product applications. The present disclosure may further be used with integrated starters, generators, or the like, commonly associated with automotive, aerospace, and other comparable mobile applications.

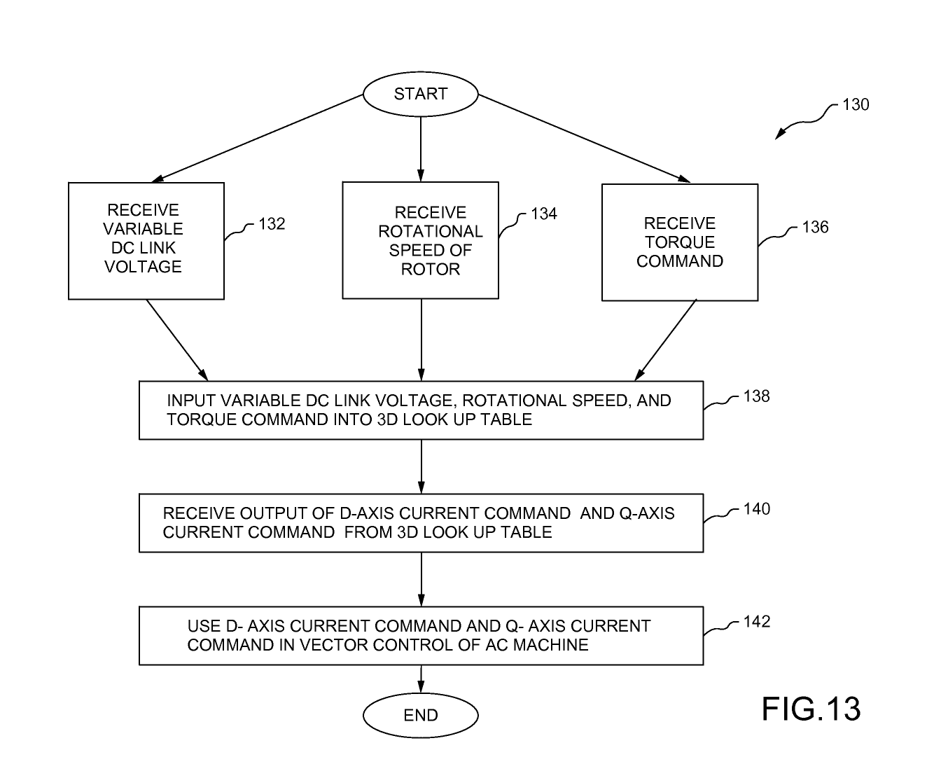

Turning now to FIG. 13, with continued reference to FIGS. 1-12, an example algorithm or process 130 for controlling an AC machine, such as the second electric machine 54, is provided, in accordance with another embodiment of the present disclosure. The process 130 may be used to control the second electric machine 54 during a retarding mode of the machine 20. At block 132, the controller 64 may receive a signal indicative of the variable DC link voltage v_{dc}. The controller 64 may receive a signal indicative of the rotational speed ωᵣ of the rotor 56 of the second electric machine 54, at block 134. At block 136, the controller 64 may receive a torque command T_{Cmd}.

At block 138, the controller 64 may input the variable DC link voltage v_{dc}, rotational speed ωᵣ, and torque command T_{Cmd} as inputs into the 3D lookup tables 88, 90 preprogrammed into the memory 66 associated with the controller 64 and configured to output a d-axis current command and a q-axis current command based on said inputs. The controller 64 may receive outputs of the d-axis current command and the q-axis current command from the 3D lookup tables 88, 90, at block 140. At block 142, the controller 64 may use the d-axis current command and the q-axis current command in a vector control strategy with PWM to control the second inverter module 46 and the second electric machine 54 during the retarding mode of operation of the machine 20.

It is to be understood that the flowchart in FIG. 13 is shown and described as an example only to assist in disclosing the features of the disclosed system, and that more or less steps than that shown may be included in the method corresponding to the various features described above for the disclosed system without departing from the scope of the disclosure.

By regulating the d-axis current command and a q-axis current command as a function of DC link voltage, in addition to speed and torque, the control system 62 of the electric drive 24 may realize an increased torque of the second electric machine 54, which may be used to drive the power source 22. In so doing, retarding energy of the machine 20 captured during downhill operation, or during other periods of retarding, may be utilized to alleviate parasitic loads tied to the power source 22, thereby drastically reducing fuel consumption by the power source 22.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto. Moreover, while some features are described in conjunction with certain specific embodiments, these features are not limited to use with only the embodiment with which they are described, but instead may be used together with or separate from, other features disclosed in conjunction with alternate embodiments.

What is claimed is:

1. A control system for an alternating current (AC) machine having a rotor and a stator, the control system comprising:
a direct current (DC) link providing a variable DC link voltage;
an inverter module operatively coupled between the DC link and the AC machine, the inverter module including a plurality of gates in selective communication with each phase of the stator; and
a controller in communication with the inverter module, the controller configured to:
receive a signal indicative of the variable DC link voltage;
receive a signal indicative of a rotational speed of the rotor;
receive a torque command; and
generate a direct-axis current command and a quadrature-axis current command using the variable DC link voltage, the rotational speed, and the torque command as inputs into a three-dimensional lookup table preprogrammed into a memory associated with the controller.

2. The control system of claim 1, wherein the three-dimensional lookup table is based at least in part on the following equation for torque:
$$T = \frac{3}{2} P \times ( {Ψ}_{f} \times {i}_{q} + ( {L}_{d} - {L}_{q} ) \times {i}_{d} \times {i}_{q} ) .$$

3. The control system of claim 2, wherein the three-dimensional lookup table is based at least in part on the following current constraint equation:
I_{S}≧\sqrt{i_{d}²+i_{q}^{d}}.

4. The control system of claim 3, wherein the three-dimensional lookup table is based at least in part on the following voltage constraint equation:
V_{DC}≧\sqrt{(ωₑ·L_{q}·i_{q})²+(ωₑ·L_{d}·i_{d}+ωₑ·ψ_{f})²}.

5. The control system of claim 1, wherein the variable DC link voltage on the DC link comes from retarding energy recovered by fraction motors.

6. The control system of claim 5, wherein the variable DC link voltage varies between an inclusive range of approximately 800 V to 2700 V.

7. The control system of claim 1, wherein the AC machine is a salient pole synchronous (SPS) machine.

8. The control system of claim 7, wherein the controller is further configured to generate a field current command as a function of the variable DC link voltage, the rotational speed, and the torque command.

9. The control system of claim 1, wherein the torque command is implemented in a speed control mode.

10. The control system of claim 1, wherein the torque command is implemented in a torque control mode.

11. A method of controlling an alternating current (AC) machine having a rotor, a stator, an inverter module operatively coupled to the stator and including a plurality of gates in selective communication with each phase of the stator, and a controller in communication with the inverter module, the method comprising:
receiving, by the controller, a signal indicative of a variable DC link voltage;
receiving, by the controller, a signal indicative of a rotational speed of the rotor;
receiving, by the controller, a torque command; and
inputting, by the controller, the variable DC link voltage, the rotational speed, and the torque command into a first three-dimensional lookup table preprogrammed into a memory associated with the controller and configured to output a direct-axis (d-axis) current command and a quadrature-axis (q-axis) current command based on said inputs.

12. The method of claim 11, further comprising providing a salient pole synchronous (SPS) machine as the AC machine.

13. The method of claim 12, further comprising inputting, by the controller, the variable DC link voltage, the rotational speed, and the torque command into a second three-dimensional lookup table preprogrammed into the memory associated with the controller and configured to output a field current command based on said inputs.

14. The method of claim 13, further comprising generating the first and second three-dimensional lookup tables based at least in part on an electromagnetic torque and a reluctance torque of the SPS machine.

15. The method of claim 11, further comprising implementing, by the controller, vector control with pulse width modulation (PWM) on the AC machine using the d-axis current command and the q-axis current command.

16. An electric drive, comprising:
a first electric machine operatively coupled to a traction device, the first electric machine configured to convert mechanical energy from the traction device into alternating current (AC);
a first inverter module operatively coupled to the first electric machine, the first inverter module configured to convert the AC from the first electric machine into a variable direct current (DC) link voltage on a DC link;
a second inverter module operatively coupled to the first inverter module via the DC link, the second inverter module configured to convert the variable DC link voltage into AC;
a second electric machine operatively coupled between the second inverter module and a power source, the second electric machine including a stator and a rotor and configured to convert the AC from the second inverter into mechanical energy for the power source; and
a controller in communication with the second inverter module, the controller configured to:
receive a signal indicative of the variable DC link voltage on the DC link;
receive a signal indicative of a rotational speed of the rotor of the second electric machine;
receive a torque command for the second electric machine;
generate a direct-axis (d-axis) current command for the second inverter module as a function of the variable DC link voltage, the rotational speed, and the torque command; and
generate a quadrature-axis (q-axis) current command for the second inverter module as a function of the variable DC link voltage, the rotational speed, and the torque command.

17. The electric drive of claim 16, wherein the controller is further configured to use a three-dimensional lookup table to accept the variable DC link voltage, the rotational speed, and the torque command, and output the d-axis current command.

18. The electric drive of claim 17, wherein the controller is further configured to use the three-dimensional lookup table to accept the variable DC link voltage, the rotational speed, and the torque command, and output the q-axis current command.

19. The electric drive of claim 18, wherein the second electric machine is a salient pole synchronous machine, and wherein the controller is further configured to use the three-dimensional lookup table to accept the variable DC link voltage, the rotational speed, and the torque command, and output a field current command.

20. The electric drive of claim 16, wherein the second electric machine reduces fuel consumption of the power source.
